(19) United States
(12) Patent Application Publication
(10) Pub. No.: US 2003/0015572 A1
(43) Pub. Date: Jan. 23, 2003

(54) Successive integration of multiple devices process and product

(76) Inventors: Tom Faska, Brookline, NH (US); Richard Stack, Amherst, NH (US)

Correspondence Address: MORGAN & FINNEGAN, L.L.P., 345 Park Avenue, New York, NY, 10154-0053, US

(21) Appl. No.: 09/896,665

(22) Filed: Jun. 29, 2001

(51) Int. Cl. B23K 35/24; B23K 1/00; B23K 31/02

(52) U.S. Cl. 228/175; 228/226; 228/230

(57) ABSTRACT

A device integration method involves attaching two components together using a first material having a first melting point, then creating a unit by attaching the two components to a third component, using a second material having a second melting point lower than the first melting point, and then attaching the unit to another component, using a third material, having a third melting point lower than the second melting point. A device having multiple components attached together using a process described herein.

### FIELD OF THE INVENTION

This invention generally relates to electronic module creation and, more particularly, to module creation in successive steps.

### BACKGROUND OF THE INVENTION

When electronic connections are made among the chips, packages and circuit boards that make up an opto-electronic module, wire bonds, which consist of short wires soldered to one or more of the chips, packages, and circuit boards, are typically used. Wire bonds are limited in their frequency response due to their long length and hence high capacitance and inductance.

Hence, using wire bonds to make high speed opto-electronic modules is undesirable.

In other cases, even if wire bonds are not used, modules are created based upon an “inside-to-outside” integration process whereby the innermost components (and those outer components that can be done in parallel) are combined, followed by integration of the combined components to each other or one or more circuit boards, etc. until the entire module is complete. Such a process is, most often, based upon the location of the components in the module and does not typically take into account the process whereby the overall module is created or the effect that integrating one component can have on another component (causing reduced life) or its connection (increasing capacitance and/or resistance). Thus, present techniques can result in a less reliable or lower performance product because integration of one component may weaken a connection, increase the capacitance and/or resistance of a connection, or increase the susceptibility to thermal and/or physical stresses of a connection, for an earlier integrated component.

Thus, even where wire bond connections are not used, the particular process used may nevertheless have an undesirable and adverse effect on the reliability and/or performance of the overall product ultimately produced.

### SUMMARY OF THE INVENTION

We have developed a process that allows for creation of a module made up of a number of components, that does not connect components using wire bonds. We have further developed a process that does not cause the integration of later components to have an adverse effect on earlier integrated components. As a result, our process results in a product that will be more reliable than the identical product produced according to the processes in the prior art.

Specifically, by using a hierarchical attachment process, we have created a packaging technique that allows optical devices to be attached to electronic chips, electronic chips to be attached to packaging and packaging to be attached to printed circuit boards, all without wire bonds. This generally allows the highest frequency response connections possible (i.e. the speed is limited only by component capabilities, not the wiring among the components). In addition, it allows for a more reliable end product.

One aspect of the invention involves a device integration method. The method involves attaching two components together using a first material having a first melting point, then creating a unit by attaching the two components to a third component, using a second material having a second melting point lower than the first melting point, and then attaching the unit to another component, using a third material, having a third melting point lower than the second melting point.

Another aspect of the invention involves a device having multiple components attached together using a process described herein.

These and other aspects described herein, or resulting from the using teachings contained herein, provide advantages and benefits over the prior art.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 is a flowchart for one example process in accordance with the invention;

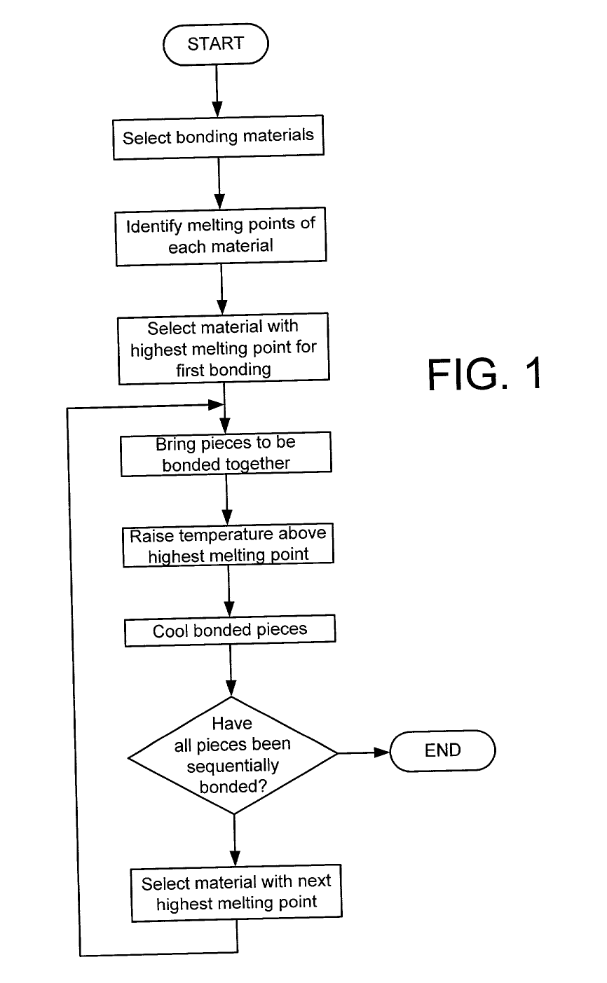

FIG. 2 shows the various components being joined according to the process of FIG. 1;

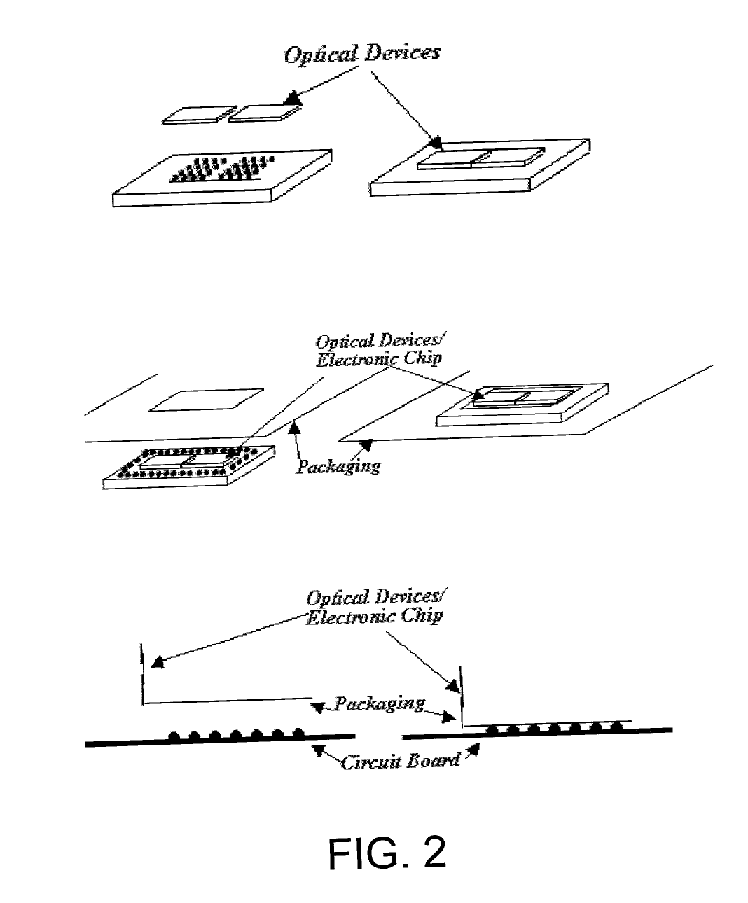

FIG. 3 is a flowchart for another example process in accordance with the invention;

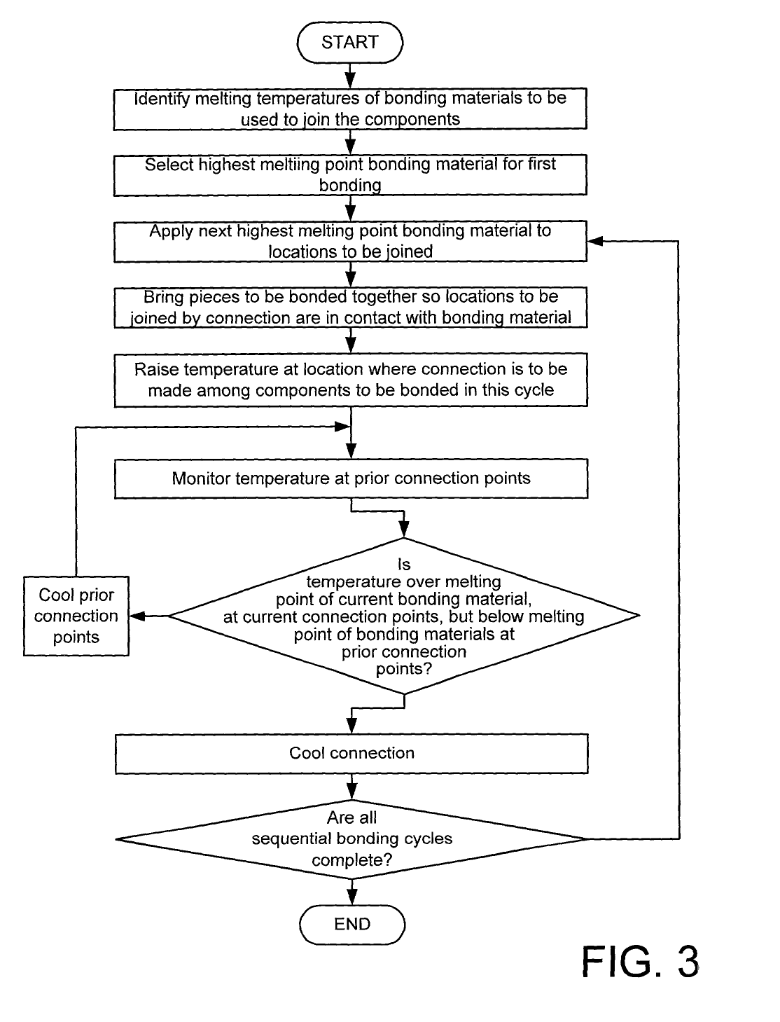

FIGS. 4A-4D show example assemblies constructed in accordance with the invention according to the teachings described herein.

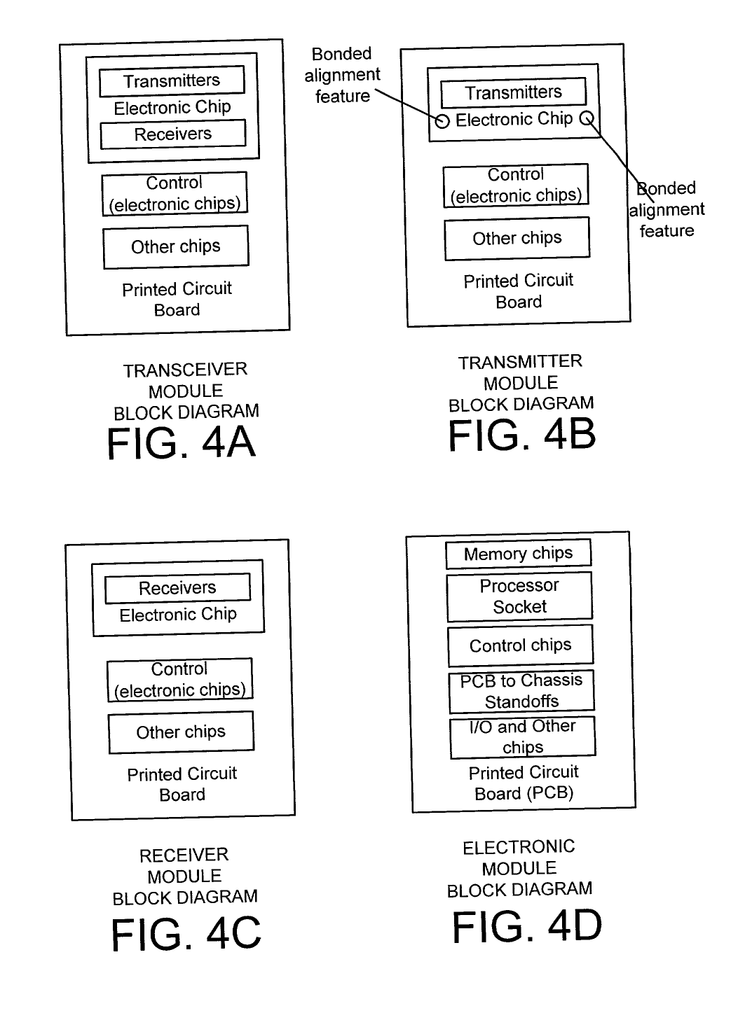

### DETAILED DESCRIPTION

In overview, we have recognized that by using different solder materials, having different melting points and attachment temperatures, and employing a particular attachment sequence related to the attachment material being used, as opposed to the components being attached, the process does not have the problems present in the prior art. Moreover, our process is well suited to creation of non-optical electronic modules and particularly well suited to the creation of high performance opto-electronic modules where reduction of capacitance, inductance and resistance are of significant concern.

In accordance with the invention, we use a sequential process whereby at least:

i) one solder material, having a first melting point and a first attachment temperature, is used to attach the first group of components together, for example, optical device(s) to an electronic chip;

ii) a second solder material, having a second melting point and second attachment temperature, is used to attach the previously joined components to another component, for example, one or more electronic chip(s) to a package; and

iii) a third solder material, having a third melting point and third attachment temperature, is used to attach one or more of the components created in ii) to another component, for example, package(s) to a printed circuit board.

The process can be extended to four or more levels of attachment by straightforward material selection and extension of the process in the same manner as above.

The materials used in the three or more different attachment processes are specifically selected because they are thermally compatible. In other words, by way of example, the integration conditions for the chip to package connection is designed to not affect the optical component to chip connection performed prior to the chip to packaging attachment.

Specifically, the melting point of the solder for a given attachment is generally selected to be the higher than that of the melting points for the solders used in the successive steps in the process.

In other words, the solder for the first attachment step has the highest melting point. The solder for the second attachment step has a lower melting point than the solder used in the first attachment step. The solder for the third attachment step has a lower melting point than both of the solders used in the preceding two attachment steps. Depending upon the particular implementation, a fourth or more attachment steps may be involved.

If any step involves a thermally sensitive adhesive other than solder, the same procedure applies. That is, its melting temperature must also be such that heating the adhesive to its melting point will not result in the temperature exceeding the melting point of the materials used for all the preceding connections, as measured at the preceding connection points.

The same is typically, although not necessarily always, true for the attachment temperatures relative to each other, i.e. the attachment temperature for a given step will be higher than that the attachment temperature of the material used in any successive step.

In some variants, it is possible to use the same material and, accordingly, the same melting and attachment temperatures for all the steps provided that the temperature measured at the preceding connection points do not exceed the melting temperature.

Notably, in some cases, the attachment temperature in one step may be higher than the melting point of a preceding step. However, this is not a problem because, through use of an encapsulant or due to the spacing of the particular components involved, at the point(s) of contact, the previously joined components will not reach a high enough temperature to have an adverse effect.

Having described our process in a general manner, the process will now be described, by way of two examples. In the first example, an opto-electronic transceiver module product is created. The product is made up of several lasers (an optical chip) integrated with one electronic chip and several photodetectors (a second optical chip) integrated with another electronic chip. The two electronic chips are integrated into a package which is integrated onto an electronic circuit board.

The second example creates a similar transceiver, except that both the optical chips (i.e. lasers chip and photodetector chip) share a common electronic chip and an additional component that is used for alignment of fibers with the optical devices is attached to the electronic chip, by way of a thermally activated glue.

### EXAMPLE 1

In this example, the part of the process, the combination of joining materials (i.e. solder metals), melting points and attachment temperatures are shown in Table 1.

TABLE 1

| | | Material Melting | Attachment |
|---|---|---|---|
| Process | Material | Point | Temperature |
| Attaching optical | 20% Au/80% Sn | 280° C. | 310° C. |
| devices to electronic IC | | | |
| Attaching IC to packaging | 95% Sn/5% Sb | 240° C. | 270° C. |
| Attaching packaging to | 63% Sn/37% Pb | 180° C. | 210° C. |
| printed circuit board | | | |

In this example, the first part of process begins with the attachment of the optical devices to an integrated circuit (IC). This is done with a material that has the highest melting point (in the example Au 20%/Sn 80% with a melting point of 280° C.). The connection points to be joined are brought together and the temperature is raised above the melting point to cause the solder to melt. The joined components are then cooled to below the melting point so that the solder is fully set.

The integrated opto-electronic IC containing the lasers and the integrated opto-electronic IC containing the detectors are then attached to the IC packaging, to create an opto-electronic module package, using a solder with a melting point lower than the prior solder material's melting point. In this case, a Sn 95%/Sb 5% solder is used (melting temperature of 240° C.). The contacts on the laser IC and the detector IC are each brought together with their respective connection locations on the IC packaging. The components are then heated to a temperature above 240° C., but less than 280° C. so the solder of the prior joint(s) do not remelt. The joined parts are then cooled to below the melting temperature of the solder to set the new joint(s).

The final part of the temperature sensitive bonding process involves the attachment of the module package(s) to a printed circuit board to create the module. This is done with a solder material which has a melting temperature lower than either of the previous two solders used. In this case, a Sn 63%/Pb 37% solder, with a melting temperature of 180° C. is used. The contacts on the parts to be joined are brought together and heated to a temperature between 180° C. and 240° C. The module is then cooled to below the melting temperature of the solder to set the new joint(s).

Thus, since each subsequent attachment involves a temperature below the temperature of all the prior attachments, the attachment does not interfere or disrupt the prior connections.

### EXAMPLE 2

In this example, a similar process is used to create a similar transceiver, except that both the optical chips (i.e. lasers chip and photodetector chip) share a common electronic chip and an additional component that is used for alignment of fibers with the optical devices is attached to the electronic chip, by way of a thermally activated adhesive glue that is not electrically conductive and has a melting temperature of 230° C. and a setting temperature of 230° C. As a result, the process is altered so that attachment of the component requiring the adhesive is performed before the attachment of the module to the printed circuit board. The steps and materials involved in the process are shown in Table 2.

TABLE 2

| | | Material Melting | Attachment |
|---|---|---|---|
| Process | Material | Point | Temperature |
| Attaching optical ICs to | 20% Au/80% Sn | 280° C. | 310° C. |
| electronic IC | | | |
| Attaching IC to packaging | 95% Sn/5% Sb | 240° C. | 260° C. |
| Attaching alignment piece | Thermal Glue | 230° C. | 230° C. |
| to packaging | | | |
| Attaching packaging to | 63% Sn/37% Pb | 180° C. | 210° C. |
| printed circuit board | | | |

The process proceeds as above. First the optical ICs are both connected to the electronic IC. Next, the opto-electronic IC is attached to the packaging by melting the solder above 240° C. but below 280° C. Then the alignment piece is bonded to the packaging using a temperature between 230° C. and 240° C. Finally, the packaging is attached to the printed circuit board using a temperature between 180° C. and 230° C.

It is well known that numerous different solders exist, from pure gold to alloys and eutectics of metals such as silver, lead, tin, antimony, bismuth, or other metals. Table 3 shows just a few of the many solders currently commercially available along with their respective approximate melting points.

TABLE 3

| | Melting |
|---|---|
| Solder Material | Temp. (° C.) |
| 81.% Au/19% In | 487 |
| 96.85% Au/3.15% Si | 363 |
| 88% Au/12% Ge | 361 |
| 100% Pb | 327 |
| 95% Pb/5% In | 314 |
| 95% Pb/5% Sn | 314 |
| 5% Ag/90% Pb/5% In | 310 |
| 1.5% Ag/97.5% Pb/1% Sn | 309 |
| 78% Au/22% Sn | 305 |
| 2.5% Ag/95.5% Pb/2% Sn | 304 |
| 2.5% Ag/97.5% Pb | 303 |
| 90% Pb/10% Sn | 302 |
| 2.5% Ag/92.5% Pb/5% In | 300 |
| 2.5% Ag/92.5% Pb/5% Sn | 296 |
| 95% Pb/5% Sb | 295 |
| 5% Ag/90% Pb/5% Sn | 292 |
| 2% Ag/88% Pb/10% Sn | 290 |
| 85% Pb/15% Sn | 288 |
| 86% Pb/8% Bi/4% Sn/1% In/1% Ag | 286 |
| 80% Au/20% Sn | 280 |
| 80% Pb/20% Sn | 280 |
| 81% Pb/19% In | 280 |
| 75% Pb/25% In | 264 |
| 70% Pb/30% Sn | 257 |
| 63.2% Pb/35% Sn/1.8% In | 243 |
| 95% Sn/5% Sb | 240 |
| 60% Pb/40% Sn | 238 |
| 97% Sn/3% Sb | 238 |
| 99% Sn/1% Sb | 235 |
| 100% Sn | 232 |
| 2.5% Ag/97.5% Sn | 226 |
| 3.5% Ag/95% Sn/1.5% Sb | 226 |
| 60% Pb/40% In | 225 |
| 3.5% Ag/96.5% Sn | 221 |
| 10% Au/90% Sn | 217 |
| 95.5% Sn/3.9% Ag/0.6% Cu | 217 |
| 96.2% Sn/2.5% Ag/0.8% Cu/0.5% Sb | 217 |
| 10% Pb/90% Sn | 213 |
| 50% Pb/50% Sn | 212 |
| 50% Pb/50% In | 209 |
| 15% Pb/85% Sn | 205 |
| 45% Pb/55% Sn | 200 |
| 20% Pb/80% Sn | 199 |
| 91% Sn/9% Zn | 199 |
| 40% Pb/60% Sn | 188 |
| 2.8% Ag/77.2% Sn/20% In | 187 |
| 89% Sn/8% Zn/3% Bi | 187 |
| 30% Pb/70% Sn | 186 |
| 40% Pb/60% In | 185 |
| 37% Pb/63% Sn | 183 |
| 37.5% Pb/37.5% Sn/25% In | 181 |
| 2% Ag/36% Pb/62% Sn | 179 |
| 30% Pb/70% In | 174 |
| 100% In | 157 |
| 5% Ag/15% Pb/80% In | 149 |
| 58% Sn/42% In | 145 |
| 3% Ag/97% In | 143 |
| 42% Sn/58% Bi | 139 |
| 48% Sn/52% In | 118 |
| 30% Pb/18% Sn/52% Bi | 96 |

Similarly, thermally activated adhesives that are non-electrically conductive exist and can be used in conjunction with the solders noted above according to the technique described herein.

Moreover, it should be further understood that the melting point of a material used for a particular step can be higher than one used in a preceding step provided that temperature at the prior connection point(s) stays below the melting point of its connection material. For example, with reference to Example 1 above, if the opto-electronic IC is coated with an encapsulent that will thermally insulate the opto-electronic IC to some extent, it may be possible to raise the temperature to above the temperature of the melting point of the material bonding the optical IC to the electronic IC because the temperature at the point of connection will not exceed the melting point due to the encapsulent. Additionally, or alternatively, if the components to be joined are sufficiently separated by space or a thermal shield or heat sink, as long as the melting temperature at the prior connection points is not exceeded that temperature can be exceeded at the new connection point. Thus, in Example 2, if a thermal shield was placed between the previously bonded components and the alignment piece or it was sufficiently spaced apart from the previous connections, the local temperature at the alignment piece connection point could exceed 240° C. provided the temperature at the prior connection points did not exceed 240° C.

Even restricting the combinations to the solders of Table 3, it will be recognized that the various specific potential combinations are too numerous to list. It should be understood that the use of different combinations of materials (such as, for example, appropriate solders selected from those listed in Table 3 and/or identified herein) according to the technique described herein will straightforwardly result in numerous variants in accordance with the invention. The important aspect not being the particular materials, but rather the relationship among the melting points of the materials used for each successive step in the process. In other words, as long as the solder materials are suitable for the particular purpose and the various components are joined in successive steps, where each successive connection involves a solder that can be melted without exceeding the melting temperature at the prior connection points, the process will work.

Finally, it should be recognized that the above referenced process need not be used for all the components of a particular assembly. For example, based upon example 1, the opto-electronic transceiver may be one part of an assembly that further includes a housing, one or more fans, connectors, cables, etc. Similarly, a particular assembly may be manufactured of multiple modules, some of which were created using the process described herein, for example that of example 2, and others which were manufactured using a prior art process, or have a module created according to one variant of the process (i.e. three specific materials) and another module created according to another variant of the process (i.e. at least one of the materials differs from the specific materials used in the first module).

Thus, while we have shown and described various examples employing the invention, it should be understood that the above description is only representative of illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments or other combinations of described portions may be available, is not to be considered a disclaimer of those alternate embodiments. It can be appreciated that many of those undescribed embodiments are within the literal scope of the following claims, and others are equivalent.

What is claimed is:

1. A device integration method comprising:
attaching two components together using a first material having a first melting point;
then creating a unit by attaching the two components to a third component, using a second material having a second melting point lower than the first melting point; and
then attaching the unit to another component, using a third material, having a third melting point lower than the second melting point.

2. The device integration method of claim 1 wherein the first material is one of the materials of Table 3.

3. The device integration method of claim 2 wherein the second material is one of the materials of Table 3.

4. The device integration method of claim 2 wherein the third material is one of the materials of Table 3.

5. The device integration method of claim 1 wherein the second material is one of the materials of Table 3.

6. The device integration method of claim 1 wherein the first material, second material and third material are the materials of Table 1.

7. The method of claim 1 wherein after attaching the unit to another component, the method further comprises:
attaching the component to an item using a fourth material, having a fourth melting point lower than the third melting point.

8. The method of claim 1 wherein the attaching two components together comprises:
raising a first connection point to a temperature higher than the first melting point.

9. The method of claim 1 wherein the attaching the two components to the third component comprises:
raising a first connection point to a temperature higher than the second melting point but lower than the first melting point.

10. The method of claim 1 wherein the attaching the unit to another component comprises:
raising a second connection point to a temperature higher than the third melting point but lower than the second melting point.

11. A device comprising:
multiple components attached together using the process of one of claims 1-10.

12. A process for manufacturing a module, made up of at least four components, the process comprising:
bringing a first component and a second component into contact at a first connection point, the first connection point comprising a contact on the first component, a contact on the second component, and a first bonding material having a first melting point;
heating the first connection point to a temperature higher than the first melting point; cooling the first connection point so as to bond the first component to the second component at the first connection point, using the first bonding material, to form a sub-unit;
bringing the sub-unit and a third component into contact at a second connection point, the second connection point comprising a contact on the sub-unit, a contact on the third component, and a second bonding material having a second melting point, the second melting point being lower than the first melting point;
heating the second connection point to a temperature higher than the second melting point but lower than the first melting point;
cooling the second connection point so as to bond the sub-unit to the third component at the second connection point, using the second bonding material, to form a unit;
bringing the unit and a fourth component into contact at a third connection point, the third connection point comprising a contact on the unit, a contact on the fourth component, and a third bonding material having a third melting point, the third melting point being lower than the second melting point;
heating the third connection point to a temperature higher than the third melting point but lower than the second melting point; and
cooling the third connection point so as to bond the unit to the fourth component at the third connection point using the third bonding material.

13. A process for creating an assembly comprising:
joining components to each other in successive processing steps using at least three different bonding materials, each having a melting temperature different from the other bonding materials, such that
i) first components are joined using the bonding material, of the at least three different bonding materials, having the highest melting temperature,
ii) after the first components are joined, second components are joined using a bonding material, of the at least three different bonding materials, having a next lower melting temperature, and
iii) after the second components are joined, third components are joined using a bonding material having a melting temperature lower than the next lower melting temperature.

14. An apparatus comprising:
a first module comprising at least two integrated circuits; and
a second module, the second module having been created according to the process of one of claims 12 or 13.

15. A method comprising:
successively joining electrical contacts on components using solders having melting temperatures such that a melting temperature of a first solder is not exceeded, at a set connection between two components, during a subsequent soldering of a connection involving at least one of the two components and a second solder, and a next subsequent soldering, involves a third solder having a melting temperature such that the melting temperatures as measured at all prior set connections is lower than the melting temperature of the third solder.

16. The device integration method of claim 15 wherein at least one of the solders comprises a material selected from the materials of Table 3.
